(19) United States
(12) Patent Application Publication
(10) Pub. No.: US 2013/0111063 A1
(43) Pub. Date: May 2, 2013

(54) ROUTING METHOD IN CONTENT-CENTRIC NETWORK

(71) Applicant: Byung Joon LEE, Daejeon (KR)

(72) Inventor: Byung Joon LEE, Daejeon (KR)

(73) Assignee: Electronics and Telecommunications Research Institute, Daejeon (KR)

(21) Appl. No.: 13/614,663

(22) Filed: Sep. 13, 2012

(30) Foreign Application Priority Data
Nov. 1, 2011 (KR) 10-2011-0112933

(51) Int. Cl. G06F 15/173

(52) U.S. Cl. 709/241

(57) ABSTRACT

Disclosed is a centralized controlling method of the process of delivering a routing packet for content transmission in a content-centric network (CCN). The routing method in a content centric network according to the present invention includes: a content distribution controller in the content centric network receiving a request for specific-content distribution from a user, determining locations of routers storing the content, and finding one of the routers to which the request from the user will be transmitted; and the content distribution controller finding an optimal path in consideration of a traffic distribution status and then transmitting a forwarding information base (FIB) to routers included in the optimal path.

### CROSS-REFERENCE TO RELATED APPLICATIONS

This application claims priority to and the benefit of Korean Patent Application No. 10-2011-0112933 filed in the Korean Intellectual Property Office on Nov. 01, 2011, the entire contents of which are incorporated herein by reference.

### TECHNICAL FIELD

The present invention relates to a centralized controlling method of the process of delivering a routing packet for content transmission in a content centric network (CCN).

### BACKGROUND ART

Recently, new architectures for Future Internet have been actively researched. A representative example of which is a content centric network (CCN). The CCN technology was proposed by Van Jacobson at PARC, which is about a new Internet architecture for performing data transfer with the name of data in a network, unlike the conventional Internet architecture with Internet Protocol (IP).

Content transmission in CCN is performed through an interest packet for a content user to request data and a data packet for a node having the requested data to respond to the request. In this case, the process of determining which nodes the interest packet will be sent via is referred to as routing. Since the transmission path of the data packet is in the reverse order of all nodes through which the corresponding interest packet has passed to the content, no other routing is needed.

FIG. 1 illustrates structures of two packets used in CCN. The steps of communication between end users in CCN are as follows. A user broadcasts an interest packet containing the name of the desired content. A router receives and delivers the Interest packet using a forwarding information base (FIB). That is, when the name of the interest packet is matched to the names in FIB entries, the interest packet is delivered to nodes designated in the matched FIB entries. The node having the content receives the interest packet and then in response thereto transmits a data packet in a reverse direction of the interest packet path.

FIG. 2 illustrates a structure of a router used in CCN. If a router receives a lot of interest packets for requesting the same data, the router stores the interface receiving the interest packets and the content name included in the interest packet in a Pending Interest Table (PIT) therein, and then transmits only the first-delivered interest packet to an upper node which can send the content.

When the router receives a data packet from a data source, the router searches entries of the PIT to check whether there is a name matched with the data packet in the PIT. If there is a name, which means that the data requested by the user has arrived, the router forwards the received data packet to the corresponding interfaces from which the interest packets were received. The router deletes the searched PIT entries and stores the forwarded data packet in a content store inside the router.

Typically, a CCN router extends a conventional routing protocol such as OSPF to construct a forwarding information base (FIB). However, when the FIB is constructed with a distributed routing protocol such as OSPF, it is difficult to implement traffic engineering where content transfer path varies depending on a traffic distribution status.

### SUMMARY OF THE INVENTION

The present invention has been made to solve such conventional problems and an object of the present invention is to provide a centralized content routing proposal for supporting effective traffic engineering on a content centric network.

An exemplary embodiment of the present invention provides a routing method in a content centric network including: a content distribution controller in the content centric network receiving a request for specific-content distribution from a user, determining locations of routers storing the content, and finding one of the routers to which the request from the user will be transmitted; the content distribution controller finding an optimal path in consideration of a traffic distribution status and then transmitting a forwarding information base (FIB) to routers included in the optimal path; the routers receiving the request for the content from the user and then converting the request into an interest packet; the routers transmitting the interest packet according to a path designated in the FIB; a router with the content stored therein receiving the interest packet and then generating a data packet for the content; and the routers transmitting the data packet in a reverse direction of the path through which the interest packet has been transmitted.

The content distribution controller may manage information about which router stores which content.

The converting of the request into an interest packet may include the router requesting the forwarding information base for processing the request from the content distribution controller when the router does not have the forwarding information base.

The routing method may further include, after the transmitting of the data packet, the content distribution controller continuously monitoring the traffic distribution status to reconstruct the forwarding information base if a usable bandwidth of the network is determined to be below an allowable level.

Another exemplary embodiment of the present invention provides a routing method in a content centric network comprising: a router receiving a request for specific content from a user and determining whether to have a forwarding information base (FIB) for processing the request from the user; the router inquiring of the content distribution controller whether to receive the FIB for the content when the router does not have the forwarding information base; the content distribution controller transmitting the forwarding information base to routers included in an optimal path when the content distribution controller determines that the requested content is required to be served in the content centric network; the routers transmitting the interest packet according to a path designated in the FIB; a router with the content stored therein receiving the interest packet and then generating a data packet for the content; and the routers transmitting the data packet in a reverse direction of the path through which the interest packet has been transmitted.

The routing method may further include the content distribution controller continuously monitoring the traffic distribution status to reconstruct the forwarding information base if a usable bandwidth of the network is determined to be below an allowable level.

According to exemplary embodiments of the present invention, the FIB may be appropriately distributed into CCN routers according to the traffic distribution status of the network to prevent network bottleneck, thereby flexibly solving network congestion due to traffic bursts. When network burden increases with an explosive increase in user requests about specific content, the FIB may be controlled to allow the respective pieces of content to be distributed through different network paths.

According to exemplary embodiments of the present invention, it is possible to replace an existing Content Distribution Network (CDN) with CCN. Centralized control of content distribution, which is one of the most important characteristics of the CDN, could not be implemented in the existing CCN. However, according to the present invention, the centralized control of content distribution in the CDN is possible even in the CCN.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 shows a structure of a packet used in a conventional content centric network.

FIG. 2 shows a structure of a router used in a conventional content centric network.

FIG. 3 shows a content centric network including a content distribution controller according to the present invention.

FIG. 4 is a flow chart illustrating a routing method in the content centric network according to an exemplary embodiment of the present invention.

FIG. 5 is a flow chart illustrating another routing method in the content centric network according to an exemplary embodiment of the present invention.

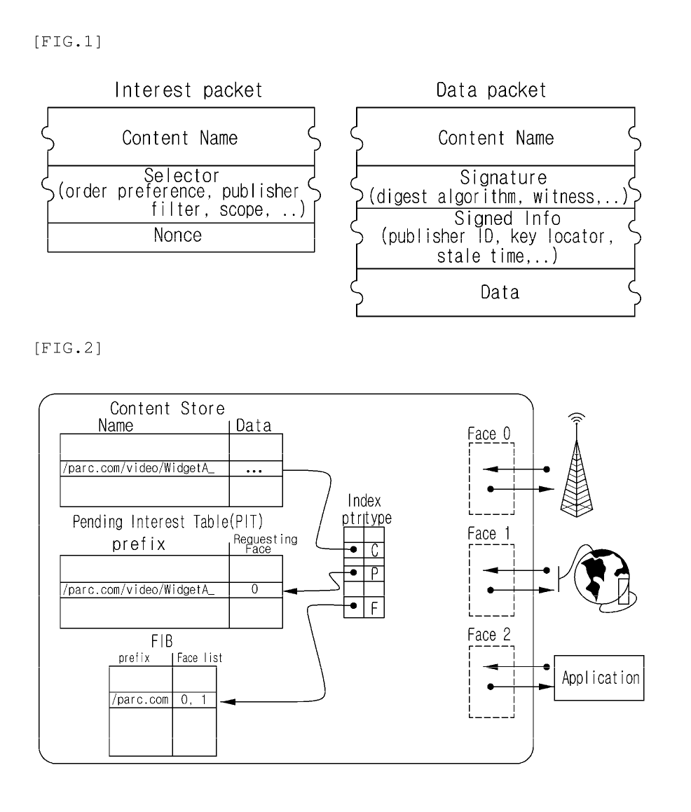

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, the routing method in the content centric network according to an exemplary embodiment of the present invention will be described with reference to the accompanying drawings.

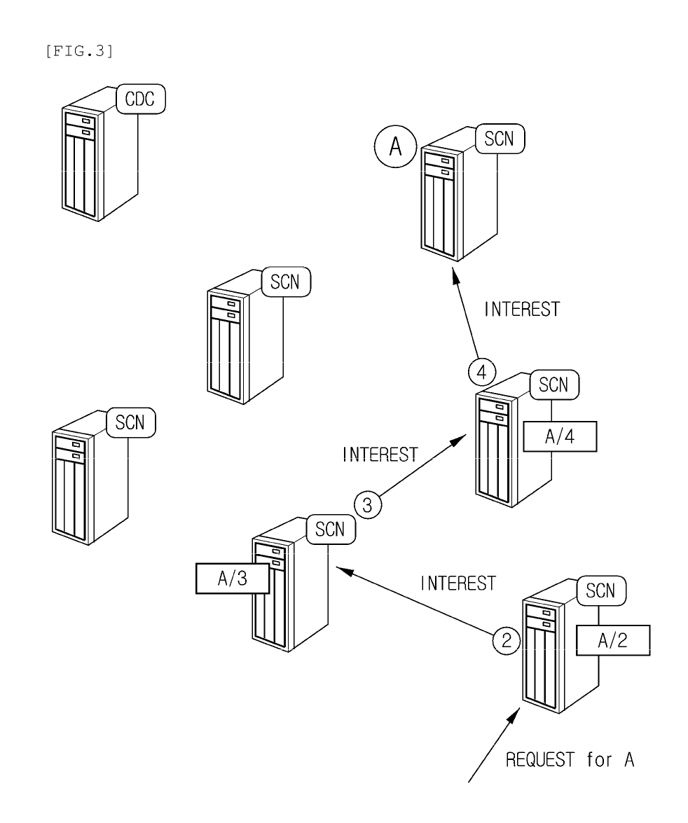

As shown in FIG. 3, the content centric network (CCN) according to the present invention includes a content distribution controller (CDC) totally finding the traffic distribution status and the content locations. All CCN routers are set to communicate with the content distribution controller.

The content distribution controller monitors the network to find how much traffic is distributed in which link and manages information about which content is located in which server or data center.

In FIG. 3, an apparatus denoted by “SCN” is referred to as the CCN router, and an apparatus denoted by “CDC” is referred to as the content distribution controller. When the content distribution controller receives a request for distribution of content “A” through the CCN from a distributer, the content distribution controller analyzes the request from the distributer to determine a location of a CCN router capable of most efficiently serving as an access point where distribution target users are located and to determine a location of a data center or server having the content “A” or a CCN router caching the content “A”. The content distribution controller uses the determined information to determine CCN routers for connecting from an access network, where the distribution target user is located, to the content and provide Forwarding Information Base (FIB) entries for serving an interest packet to the router.

For example, the content distribution controller, denoted by “CDC” in FIG. 3, finds the content “A” to be in a CCN router located in an upper portion of FIG. 3 and then a content distribution target user's request to be transmitted to a CCN router located in the lower portion of FIG. 3. Next, the content distribution controller finds an optimal path from the CCN router in a lower portion to the CCN router which has the content “A” in consideration of traffic distribution status and then transmits a forwarding information base (FIB) for interest packet routing to all CCN routers which exist on the corresponding path. In FIG. 3, items denoted in black boxes are forwarding information base entries. For example, A/2 denotes that an interest packet for requesting the content “A” should be sent to a second port, and A/3 denotes that an interest packet for requesting the content “A” should be sent to a third port. Accordingly, when a user send a request for the content “A” to the CCN router located in the lower portion of FIG. 3, the corresponding request is converted into an interest packet and then transmitted to the CCN router located in the upper portion of FIG. 3 according to the path designated in the forwarding information base. The corresponding CCN router generates a data packet for the content “A” cached therein to transmit the data packet in a reverse direction of the path through which the interest packet has been transmitted.

The content distribution controller provides the forwarding information base to the network upon a content user's request as well as a content distributer's request. For example, when the CCN router in the lower portion of FIG. 3 receives the request for the content “A” but does not have the forwarding information base entry for processing the request, the CCN router inquires of the content distribution controller whether to receive the forwarding information base for the content. When the content distribution controller receives the request for the forwarding information base, the content distribution controller checks information included in the request to determine whether the requested content should be served through the content centric network. If the requested content should be served through the content centric network, the content distribution controller provides the forwarding information base entries for serving the content.

When the content distribution controller continuously monitors a status of forwarding information bases provided in the content centric network in addition to the traffic distribution status to determine that a usable bandwidth of the network was reduced below an allowable level, the content distribution controller may reconstruct the forwarding information base and thus reconstruct the path for content distribution without a request of a distributer or user.

According to the above procedure, a centralized control is possible to a distribution path of the content served through the content centric network to perform traffic engineering for a network such that the content may be smoothly distributed at all times.

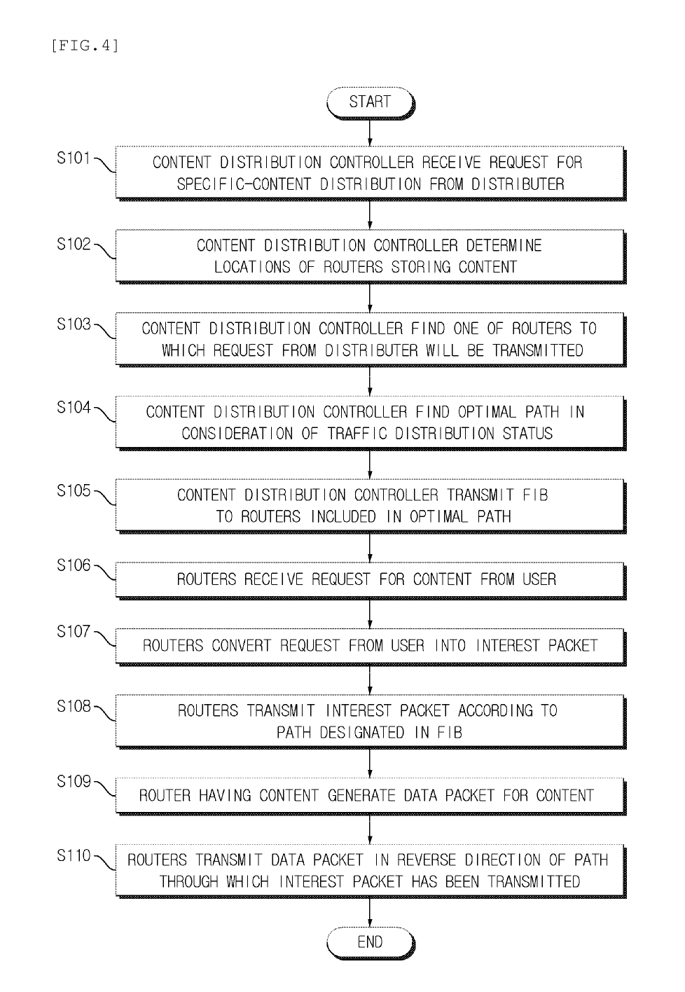

FIG. 4 is a flow chart illustrating a routing method in a content centric network according to an exemplary embodiment of the present invention. Referring to FIG. 4, the routing method in the content centric network according to an exemplary embodiment of the present invention is summarized as follows.

First, when a content distribution controller provided in the content centric network receives a request for specific-content distribution from a distributer (S101), the content distribution controller determines locations of routers storing the content (S102) and finds one of the routers to which the request from the distributer will be transmitted (S130).

The content distribution controller finds an optimal path in consideration of a traffic distribution status (S104) and then transmits a forwarding information base (FIB) to routers included in the optimal path (S105).

The routers receive the request for the content from a user (S106) and convert the request into an interest packet (S107).

The routers transmit the interest packet according to a path designated in the forwarding information base (S108).

A router storing the content receives the interest packet and then generates a data packet for the content (S109).

The routers included in the optimal path transmit the data packet in a reverse direction of the path through which the interest packet is transmitted (S110).

The content distribution controller continuously monitors the traffic distribution status to reconstruct the forwarding information base if a usable bandwidth of the network is determined to be below an allowable level.

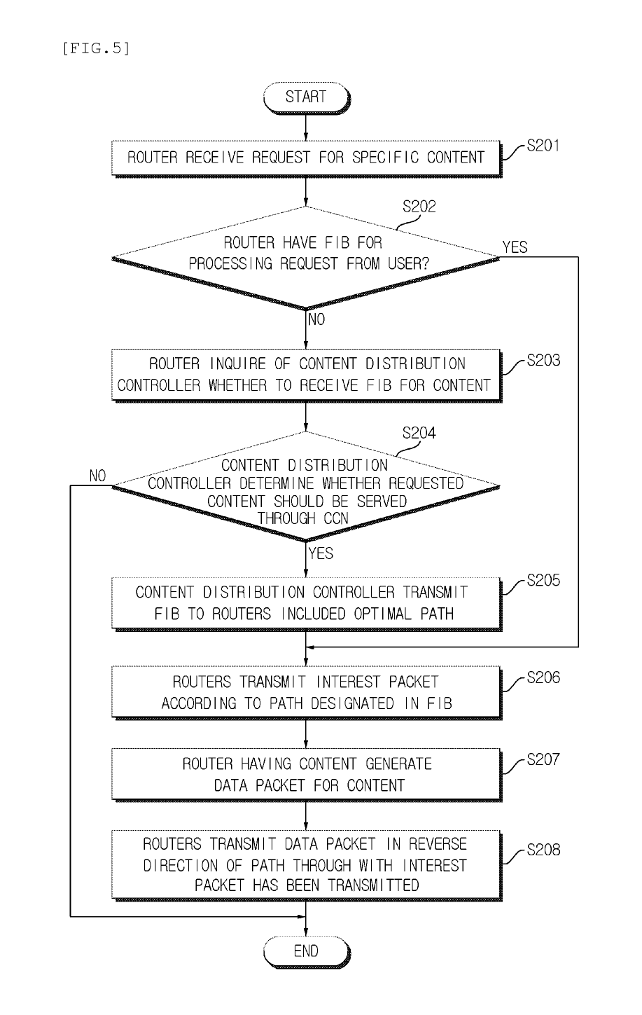

FIG. 5 is a flow chart illustrating another routing method in a content centric network according to an exemplary embodiment of the present invention. Referring to FIG. 5, the routing method in the content centric network according to an exemplary embodiment of the present invention is summarized as follows.

First, a router receives a request for specific content from a user (S201) and determines whether there is a forwarding information base for processing the request from the user (S202).

When the router does not have the forwarding information base for processing the request, the router inquires of the content distribution controller whether to receive the forwarding information base (S203). The content distribution controller receives the inquiry. When the content distribution controller determines that the requested content should be served through the content centric network (S204), the content distribution controller transmits the forwarding information base to routers included in an optimal path (S205). To the contrary, when the router determines that there is the forwarding information base for proceeding the request, the flow proceeds to the step of transmitting an interest packet (S206) without the step of inquiring of the content distribution controller.

The routers included in the optimal path transmit an interest packet according to a path designated in the forwarding information base (S206).

A router storing the content receives the interest packet and then generates a data packet for the content (S207).

The routers included in the optimal path transmit the data packet in a reverse direction of the path through which the interest packet has been transmitted (S208).

During and after the plurality of steps as described above, the content distribution controller continuously monitors the traffic distribution status to reconstruct the forwarding information base if a usable bandwidth of the network is determined to be below an allowable level.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A routing method in a content centric network comprising:
a content distribution controller in the content centric network receiving a request for specific-content distribution from a user, determining locations of routers storing the content, and finding one of the routers to which the request from the user will be transmitted; and
the content distribution controller finding an optimal path in consideration of a traffic distribution status and then transmitting a forwarding information base (FIB) to routers included in the optimal path.

2. The routing method of claim 1, further comprising after the transmitting of an FIB to routers:
the routers receiving the request for the content from the user and then converting the request into an interest packet;
the routers transmitting the interest packet according to a path designated in the FIB;
a router with the content stored therein receiving the interest packet and then generating a data packet for the content; and
the routers transmitting the data packet in a reverse direction of the path through which the interest packet has been transmitted.

3. The routing method of claim 2, wherein the content distribution controller manages information about which router stores which content.

4. The routing method of claim 2, wherein the converting of the request into an interest packet comprises the router requesting the forwarding information base for processing the request from the content distribution controller when the router does not have the forwarding information base.

5. The routing method of claim 2, further comprising:
after the transmitting of the data packet, the content distribution controller continuously monitoring the traffic distribution status to reconstruct the forwarding information base if a usable bandwidth of the network is determined to be below an allowable level.

6. A routing method in a content centric network comprising:
a router receiving a request for specific content from a user and determining whether to have a forwarding information base for processing the request from the user;
the router inquiring of the content distribution controller whether to receive the forwarding information base for the content when the router does not have the forwarding information base; and
the content distribution controller transmitting the forwarding information base to routers included in an optimal path when the content distribution controller determines that the requested content is required to be served in the content centric network.

7. The routing method of claim 6, further comprising:
the content distribution controller continuously monitoring the traffic distribution status to reconstruct the forwarding information base if a usable bandwidth of the network is determined to be below an allowable level.
